(19) United States
(12) Patent Application Publication
(10) Pub. No.: US 2015/0295873 A1
(43) Pub. Date: Oct. 15, 2015

(54) THREADED MESSAGING

(71) Applicant: Novastone Media Ltd, London (GB)

(72) Inventor: Douglas Orr, Windsor (GB)

(21) Appl. No.: 14/685,871

(22) Filed: Apr. 14, 2015

(30) Foreign Application Priority Data
Apr. 14, 2014 (GB) 1406695.5

(51) Int. Cl. H04L 12/58; G06F 3/0484; G06F 3/0482

(52) U.S. Cl. CPC H04L 51/16; H04L 51/046; G06F 3/0482; G06F 3/04842

(57) ABSTRACT

A user device comprising a processor configured to execute a client capable of transmitting and receiving instant messages to and from a plurality of remote user accounts instantiated on a plurality of remote devices, wherein the client is configured to: attribute to each instant message a thread identifier independently of the remote user account; and group the instant messages for presentation to a user according to the thread identifier and independently of the remote user account.

### CROSS-REFERENCE TO RELATED APPLICATIONS

This application claims priority to UK Patent Application No. 1406695.5 titled “Threaded Messaging,” which was filed on Apr. 14, 2014. The disclosure of the foregoing application is incorporated herein by reference in its entirety.

### TECHNICAL FIELD

This invention relates to presenting messages in a threaded format.

### BACKGROUND

There are several established methods for users of electronic devices to communicate with each other by sending messages over wired and wireless communication networks. One such example is SMS messages, or “text messages”. SMS messages are carried in accordance with protocols defined in mobile telephony standards. SMS messages are passed from one item of user equipment (such as a mobile telephone) to another. As conventionally implemented, the payload of an SMS message that can be populated by a user consists of a short text field, with no specific mechanism for a user to indicate other data relating to the message, such as its subject. For this reason, an item of user equipment will normally present SMS messages that have been sent and received as a simple list, either of all the available messages, or of messages grouped by the identity of the user with whom the messages have been exchanged.

Another popular form of communication is email. Email is supported by clients on many platforms, including personal computers and mobile telephones. Email provides the scope for a user to populate a message with many fields, including a subject, a priority, an address to which replies should be sent and so on. Email supports attaching files to messages, encryption of messages and many other features. These complexities make email popular for business communications. However, although many people do use email for casual communication it is generally unsuited to that purpose. One reason for that is that email client applications are typically somewhat cumbersome to use, as a result of their support for the many features that email offers. Another reason is that people normally use a single email account for both detailed correspondence and casual communication, and so the email client will normally display the casual messages together with the detailed correspondence. That diminishes the immediacy of the casual messages.

More recently, a form of communication known as instant messaging (IM) has grown in popularity. Early IM clients include AOL Instant Messenger and MSN Messenger. More recent clients include MySpace IM, Skype and WhatsApp. IM is conventionally supported by a client application running on a client device. The client application presents a user interface from which a user can generate messages for transmission to other users, and view messages received from other users. When a message is to be transmitted the client application can cause the client device to transmit that message to one or more remote servers operated by the organisation that provides the IM platform in question. Those servers then forward the message to the client application of the intended recipient. Unlike SMS messaging, which is implemented by mobile telephony standards, the IM messages are typically transmitted over internet protocols. Compared to email, the IM messages are restricted in functionality and pass via dedicated servers operated by the organisation that provides the IM platform in question. The IM messages can be presented in a separate client application from email messages, making them appear more immediate and conversational. It has been found that these features make instant messaging very popular for message-based chatting among users.

Typically, a user communicates via IM by first logging into an IM account by means of the IM client application. Once logged in, the user can see which of his/her contacts are also logged in. This information is derived from the servers of the IM provider. The user can communicate with one more of those users. Some IM clients allow the user also to transmit messages to contacts who are not currently logged into their account, who can then view the messages once they are logged in.

Whilst IM can provide a more user-friendly means of communication between users than email, particularly if the users want to engage in chat, existing IM implementations suffer from the drawback that it is difficult to store or log conversations for future reference. In addition, typical IM clients present messages as a list grouped only by the identity of the user with whom the messages have been exchanged. This makes IM unsuitable for more directed forms of communication.

It is apparent that there are certain purposes for which existing forms of communication are unsuited. For example, if a group of users want to casually discuss purchasing dresses and shoes, SMS has the disadvantage that the content of its messages cannot readily integrate photographs of the articles, email has the disadvantage that it is cumbersome for casual discussions and IM has the disadvantage that the communications relating to dresses cannot easily be kept separate from the communications relating to shoes. In another application, if a user wants to discuss various investment possibilities with his or her bank, SMS has the disadvantage that it is perceived as informal, email has the disadvantage that it is difficult to ensure security and that the communications might get ignored amongst other email correspondence, and IM has the disadvantage that the communications relating to different investment possibilities cannot easily be kept separate from each other.

There is therefore a need for an improved means of communicating with users by sending messages via an electronic device.

### SUMMARY OF INVENTION

According to one aspect of the present disclosure there is provided a user device comprising a processor configured to execute a client capable of transmitting and receiving instant messages to and from a plurality of remote user accounts instantiated on a plurality of remote devices, wherein the client is configured to: attribute to each instant message a thread identifier independently of the remote user account; group the instant messages for presentation to a user according to the thread identifier and independently of the remote user account; associate at least some of the thread identifiers with respective thread descriptors; and permit a user to modify a thread descriptor at a time when there exist instant messages to which the thread identifier associated with that thread descriptor is attributed.

The client could be configured to permit the user to compose and send a reply message responsive to a message received by the client, by a process including allocating to the reply message the same thread identifier as attributed to the received message.

The client could be configured to permit the user to compose and send a non-reply message, by a process including allocating to the non-reply message a new unique thread identifier.

The client could be configured to group instant messages for presentation to a user by displaying a single indicia in representation of a plurality of messages having the same thread identifier, and the client is responsive to the user selecting that indicia to display at least some of the said plurality of messages.

Each of the thread descriptors could be in the form of a text string.

The client could be configured to group instant messages for presentation to a user by displaying the text string in representation of a plurality of messages having the same thread identifier, and the client is responsive to the user selecting that text string to display at least some of the said plurality of messages.

The client could be configured to permit a user to modify a thread descriptor associated with a thread identifier by changing the text string and to, in response to such a change transmit to a remote server an indication of the changed text string and the thread identifier.

The client could be configured to receive from a server an indication of a change to the change text string associated with a thread identifier and to, in response to such an indication, change the text string it associates with the thread identifier.

The client could be configured to permit a user to modify a thread descriptor associated with a thread identifier by changing the text string and to, in response to such a change, group the instant messages having that same thread identifier for presentation to a user by displaying the changed text string in representation of said plurality of messages.

The client could be configured to, in response to a user modifying a thread descriptor, transmit a message of a type such as to indicate the modified thread descriptor to remote user accounts with which the user device has exchanged instant messages to which the thread identifier associated with the modified thread descriptor is attributed.

The client could be configured to modify a thread descriptor in response to receiving a message of the said type indicating the modified thread descriptor.

The client could be configured to group instant messages for display to a user by displaying the modified thread descriptor as indicated in the received message in representation of the plurality of messages having the same thread identifier associated with said modified thread descriptor.

The client could be configured to maintain, for each thread identifier, a log of each modification made to the associated thread descriptor, and the client is configured to display the log for a thread identifier to a user.

The client may be configured to receive a search term input by a user. In response to that input the client may be configured to identify a thread identifier whose thread descriptor or any of whose previous thread descriptors match the search term; and display one or more messages and or thread descriptors corresponding to that thread identifier. The client may identify the thread identifier by performing a search through the said log. Alternatively, it could communicate the search term to a remote server, and remote server could communicate to the client the thread identifier(s) whose current or previous thread descriptors match the search term.

The client could be configured to communicate via a server entity dedicated to the intercommunication of all clients with which the client can communicate.

According to a second aspect of the present disclosure there is provided a user device for communicating with a remote user account via instant messaging, comprising: a screen; a graphical user interface for display on the screen; a processor operable to run a client, the client being configured to: display by means of the graphical user interface a plurality of message threads, each of the message threads comprising a stream of instant messages transmitted between the client and a single remote user account; receive an input from a user of the user device to select a message thread from the displayed plurality of message threads; and display on the graphical user interface a stream of instant messages characterised by the selected message thread.

The message thread could be independent of the entities of user accounts between which communications have been exchanged in the message thread.

The client could be configured to permit a user of the device to create a message as a reply to a message in the displayed stream, and the device comprises a network interface for transmitting the created message as an instant message over a network to a user account.

Each of the plurality of threads of instant messages could be characterised by a respective title.

Each of the plurality of message threads could be displayed according to a title characterising the respective instant message stream.

The title characterising the displayed stream of instant messages for the selected message thread could be changeable by a user of the local device at a time when there exist instant messages as part of the displayed stream.

The processor could be configured to, once the title characterising the displayed stream has been changed by the user, display the selected message thread according to the changed title.

The client could be stored in memory.

According to a third aspect of the present disclosure there is provided a user device for communicating with a plurality of remote user accounts via instant messaging, comprising: a screen; and a processor operable to run a client, the client being configured to: display a graphical user interface on the screen, the graphical user interface comprising a plurality of message threads wherein each of the plurality of message threads comprises a respective stream of instant messages transmitted between the user device and a remote user account and is displayed according to a title characterising the respective stream, wherein message threads are displayed for a plurality of remote user accounts and a plurality of message threads are displayed for at least one remote user account.

The device could be one of: a smart phone, tablet, laptop, computer, augmented reality device or console.

According to a fourth aspect of the present disclosure there is provided a user device comprising a processor configured to execute a client capable of transmitting and receiving instant messages to and from a plurality of remote user accounts instantiated on a plurality of remote devices, wherein the client is configured to: attribute to each instant message a thread identifier independently of the remote user account and the content of the message; group the instant messages for presentation to a user according to the thread identifier and independently of the remote user account; associate at least some of the thread identifiers with respective thread descriptors; and permit a user to modify a thread descriptor at a time when there exist instant messages to which the thread identifier associated with that thread descriptor is attributed.

The client may be configured to allocate to the reply message the same thread identifier as attributed to the received message in response to a user designating a series of existing messages to which said identifier is attributed.

The server may be configured to store the thread identifiers.

The client may be configured to permit a user to select a group of messages having a common thread identifier and compose a message as part of the selected group; the client being configured to allocate to the composed message the same thread identifier as attributed to the messages of the group in response to the user selecting the group of messages.

According to a fifth aspect of the present disclosure there is provided a user device for communicating with a remote user account via instant messaging, comprising: a screen; a graphical user interface for display on the screen; a processor operable to run a client, the client being configured to: attribute to each instant message a thread identifier independently of the remote user account and content of the message; display by means of the graphical user interface a plurality of message threads, each of the message threads comprising a stream of instant messages transmitted between the client and a single remote user account that share a common thread identifier; receive an input from a user of the user device to select a message thread from the displayed plurality of message threads; display on the graphical user interface a stream of instant messages characterised by the selected message thread.

According to a sixth aspect of the present disclosure there is provided a user device for communicating with a plurality of remote user accounts via instant messaging, comprising: a screen; and a processor operable to run a client, the client being configured to: attribute to each instant message a thread identifier independently of the remote user account and content of the message; display a graphical user interface on the screen, the graphical user interface comprising a plurality of message threads wherein each of the plurality of message threads comprises a respective stream of instant messages transmitted between the user device and a remote user account that share a common thread identifier and is displayed according to a title characterising the respective stream, wherein message threads are displayed for a plurality of remote user accounts and a plurality of message threads are displayed for at least one remote user account.

### BRIEF DESCRIPTION OF THE DRAWINGS

The present invention will now be described by way of example with reference to the accompanying drawings. In the drawings:

FIG. 1 shows an example of a communication network.

FIG. 2 shows an example of a user device for use within the communication network.

FIG. 3 shows an example of a display page presented to a user for selecting a message according to an embodiment of the present invention.

FIG. 4 shows a series of exemplary display pages presented to a user as the user navigates a graphical user interface according to an embodiment of the present invention.

### DETAILED DESCRIPTION OF THE INVENTION

Embodiments of the present invention can be directed to enabling users of electronic devices to communicate via a communication network in a user-friendly manner that will enable the users to more easily record and locate particular topics of conversation of interest.

In the system described below, communication clients run on respective user devices. Each communication client implements an instant messaging or “chat” function, permitting users of compatible communication clients to chat via the exchange of instant messages with each other.

The communication clients are configured to be capable of exchanging the messages in a substantially instantaneous manner, provided the communication clients have adequate network connectivity. The communication clients are arranged to communicate via at least one server function that is dedicated to supporting the intercommunication of the communication clients. The server function can be provided by the same entity (e.g. the same business or provider) that provides the communication clients to users. That is, unlike email, in which the message protocol permits messages to be transmitted via multiple mail servers which can be operated by multiple different organisations, an instant message protocol can restrict the messages such that they are switched only by servers that are operated by the organisation that provides the instant messaging platform. For example, in email a message transmitted from a user account on one client platform to another user account on a different client platform can pass through servers operated by the different organisations running the platforms. This interoperability between different mail servers means that the backend architecture in email is not under the control of a single entity. As a result, there is little or no restriction on a user's ability to transmit an email to another user (provided that they have the recipient's email address) because mail servers operated by one organisation can be accessed by users running a client platform provided by a different organisation. In contrast, because instant messages can pass through dedicated servers operated by the organisation providing the platform, that organisation can control the user's access to the backend architecture. Users communicating via instant messaging can therefore communicate using a single platform.

In the present system this restriction on messaging traffic can be implemented by the protocol of the instant messaging system requiring communications between every client and the server side of the system to take place over an authenticated communication channel.

The single platform nature of instant messaging makes the transmission and reception of messages can appear more fluid, or real-time, as compared to email. This can be achieved by appropriate design of the user interface of the instant messaging client, which can be enforced by the requirement for authentication between each client and the server side of the system. The cross-server architecture of email can lead to a latency associated with the transmission and reception of messages. The latency can be indeterminate and may vary with time, for example in dependence on the network conditions. Consequently, a conversation conducted by email can often appear asynchronous to the users. A conversation conducted via instant messaging may not suffer from the same limitations and as a result can appear more synchronous and natural to the user.

The communication clients and the server function are configured to exchange messages that can include a body field, a sender field, a recipient field, a subject field and a thread identifier. The body field can include any one or more of text, images, sound, video and other content. The sender field identifies a user account from which the message was sent. The recipient field identifies one or more recipient user accounts to which the message is directed. The subject field can be used to indicate a subject of the message. The thread identifier is a unique identifier that identifies a thread to which the message belongs.

When a user creates a new message using an instance of the communication client, he can input content for the body field of that message, one or more recipients for the message and optionally content for the subject field of the message. The communication client forms a message having the entered attributes. If the message is created as a reply to an existing message then the communication client gives the message the same thread identifier as the existing message. If the message is not created as a reply then the communication client gives the message a new unique thread identifier. The unique thread identifier could be formed from an identifier of the user account from which the message was created (which could be constrained to be unique by the operator of the system) and a serial number for messages created from that account. It could contain a pseud-random element. The thread identifier may therefore be independent of the content of the message to which it is attributed.

Once the message is created, the user can select to send it. This selection causes the user's communication client to transmit the message to the server function. The server function stores a copy of the message and also transmits the messages to communication clients to which the recipient user account(s) are authenticated. If those user accounts are not currently authenticated to the system then the server entity could delay sending the message to them until they are logged in.

Each communication client can display a list of messages sent and received by that client. This may be done in various modes.

In a first mode, a user of the communication client can select another user account. This causes all messages sent from his user account to that user account, and received by his user account from that user account, to be presented in a list. The list may be truncated to fit on the screen of the device that the user is using. The messages in the list may be grouped by various criteria. Grouping implies that for a set of multiple messages only one indicator is presented in the list, and that on the user selecting that indicator the communication client will display multiple individual messages in that set. One example is that the messages could be grouped by thread identifier. Thus the user can select a user account, view a list of indicia each of which represents a thread identifier under which the user has exchanged messages with that user account, and then select one of those indicia to view the individual messages under that thread identifier. The indicia may indicate the subject of the messages under that thread identifier.

In a second mode, a user of the communication client can cause all messages sent from his user account to any user account and received by his user account from any user account to be presented in a list. The list may be truncated to fit on the screen of the device that the user is using. The messages in the list may be grouped by thread identifier. Thus the user can view a list of indicia each of which represents a thread identifier under which the user has exchanged messages with any user account, and then select one of those indicia to view the individual messages under that thread identifier.

It has been found that this arrangement provides a highly advantageous mechanism for communicating. It combines the immediacy of SMS and IM with only a selected element of the organisational capabilities of email. This makes it highly suitable for collaborative working and discussion in a way that none of SMS, IM and currently satisfy.

A thread identifier may be associated with a thread descriptor so that messages with the same thread identifier are grouped together for presentation to the user by displaying the thread descriptor in representation of the plurality of instant messages having the same thread identifier. The thread descriptor could be in the form of a text string. The text string may be chosen by the user who transmitted the first message under that thread identifier. It may, for example, be chosen so as to indicate the subject matter of the messages transmitted with that identifier, and could be seen as a title for that message stream. If the user does not select a particular text string, a default string may be presented. For example, the default string may be blank, or it could take information from the body field of one of the messages from the group, such as a first set of words or characters from the text of the first message with that identifier.

The communication clients provide the facility for a user to change the subject of a thread after the thread has been created. When this happens the communication client on which the subject was changed transmits an indication of the change to the server, and the server propagates the change to the clients whose user accounts are participating in the thread. This may be done in a number of ways. Where each message contains a subject field, as described above, the subject fields of existing messages can be changed at clients and in the storage of the server. Alternatively, the clients and the server may maintain a relational database in which there is a table that indicates the current subject corresponding to each relevant thread identifier. Thus the server may be configured to store the thread identifiers. When a new thread is created a row is added to that table and populated with the thread identifier and original subject of the thread. Then when the subject is changed only that table is updated. The server informs the clients of updates to the table, and the clients utilise the table to establish the subject to display when presenting messages or indicia representing grouped messages to users.

Thus, in one example of the system there may be a server side constituted by one or more server entities, and a client side constituted by multiple client devices each running a respective instant messaging client. The instant messaging client is configured to implement an instant messaging protocol for communicating with the server side over a network such as the internet, and to provide a user interface for displaying received messages and receiving input defining messages to be sent. The instant messaging protocol is such that the server side, which performs all switching of messages between users, will not accept messages from or send messages to a client unless that client is communicating with the server side over an authenticated channel. The authenticated channel could be implemented using conventional cryptographic techniques. A user of one client can compose a message to a user of another client. The message can comprise data identifying the recipient user and data defining content of the message. The message may or may not include a subject or thread descriptor. Conveniently, if the thread descriptor is left blank when the user composes the message it may be automatically populated by the client of the user who composed the message, for example to consist of the first part of the message content. The client will not prompt the user to complete the thread descriptor if it is left blank. The ability to leave the thread descriptor blank reduces the overhead in starting a new thread. The recipient can then reply to the message, meaning that a new message in the same message thread is sent to the first user. That reply message will therefore have attributed to it the same thread identifier as the received message. Similarly, the first user can reply to that reply, forming a further message in the same thread, and so on. The client of each user is configured to provide a mode in which it displays all the messages in that thread collected together, for example as a list ordered by time of sending. The messages of a thread can be collected under a common identifier for the thread. That can be the thread descriptor. The clients provide each user with the ability to change the thread descriptor at any time after the thread has been initiated. The clients are configured so that when the descriptor is changed, that change automatically propagates to all the messages in that thread, and for all users who are engaged in that thread. That provides a mechanism for the users to update the thread with a real-time indication of the subject matter of the thread as it changes.

In the following description and in the drawings, like reference numerals denote like components.

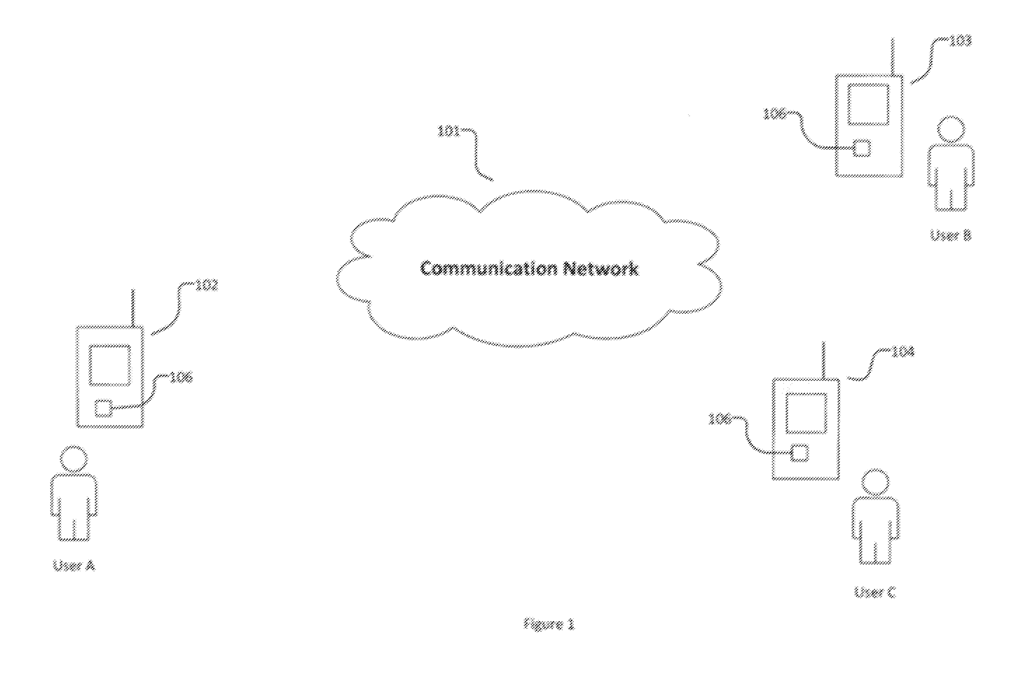

FIG. 1 is a schematic diagram illustrating users communicating over a communication network 101. In the diagram, user A may use electronic device 102 to communicate with user B and/or user C, who are associated with user devices 103 and 104 respectively. Each user device may be an electronic device such as, for example, a mobile phone, a smartphone, a tablet, a laptop, personal computer (PC), augmented reality device (for example video-equipped glasses) or a games console; or it may be some other kind of communication device.

The network 101 may be any kind of communication network and may be made up of wired and/or wireless elements. It may include a wireless cellular network such as a 3G or LTE network, a publicly accessible data network such as the internet and/or short-range wireless access networks such as IEEE 802.11 and/or Bluetooth networks.

Each user device implements a communication client 106 to enable a user of the device to communicate. The client 106 may be in the form of dedicated hardware, or may alternatively be provided by software. The client may be in the form of a mobile application, or app. It may be pre-installed on the user device at manufacture or it may be downloaded and installed on the device by a user after manufacture, e.g. from an on-line store. The communication client 106 can be run or executed on the user device to enable the user of the device to communicate with other users also running the client on their devices.

Each user has an identity under which he or she is portrayed in the communication environment supported by the communication client. That identity may be linked to the device on which the client is running, to an identity module located in that device, or to a user account by means of which the user has authenticated himself to the client. A user may have access to several devices on which the client is installed. The user may then authenticate to each client using the same account. In this way, the user can receive messages transmitted to his account using any of the devices running the client.

The client can be used to transmit and receive messages including subject matter of various forms. For example, the messages could include any one or more of text, images, sound and video. The client could support real-time voice communication, for example in the form of voice-over-IP (VoIP).

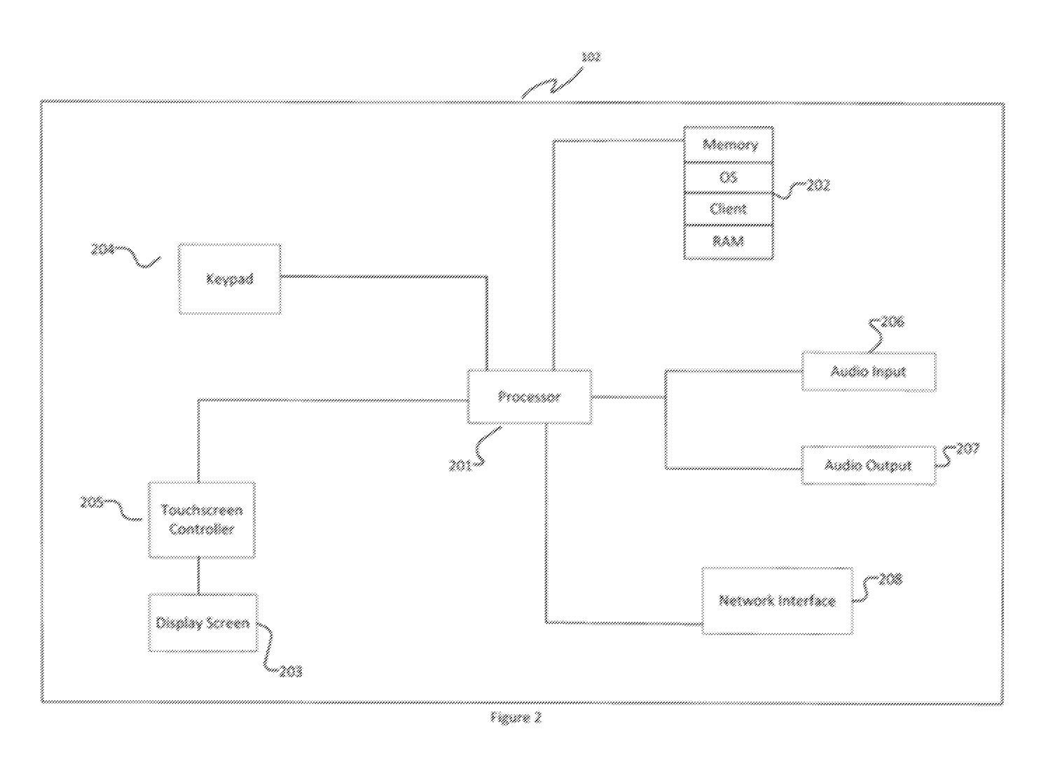

FIG. 2 is a schematic illustration of the user device 102. The device comprises a processor 201, a memory 202, a display screen 203 and a keypad 204. The keypad 204 is an input device that enables the user to enter alphanumeric symbols to compose messages, and may also provide a navigation button to enable the user to navigate the graphical user interface displayed on the screen 203.

The display screen may be a touchscreen, in which case it can functions as an input device such that a user of the device can navigate through various menus displayed on the screen by touching the screen, either with his/her finger or with a stylus. In the event the screen is a touchscreen, the device 102 comprises a touchscreen controller 205 configured to interpret touches on the screen and to process that information to effect an action. If the screen is a touchscreen there may be no need for the keypad 204 as the device may permit the user to enter text by means of the touchscreen.

The device also comprises an audio input 206 such as a microphone, and an audio output 207 such as a speaker. The microphone can be used to receive an audio input from a user of the device and the speaker can be used to output an audio signal received at the user device, such as during a telephone conversation.

The memory 202 may include volatile memory such as RAM, as well as non-volatile memory, such as ROM. The device includes an operating system (OS) which is stored in the memory and which is executed by the processor 201. The communication client 106 is stored in the memory and when executed by processor 201 is run on the operating system. In addition to the communication client 106, the memory may store other applications that can be run on the OS, as is known in the art.

The device also comprises a network interface 208 to facilitate the transmission of data to, and reception of data from, the communication network. The network interface could be a wired or wireless communication transceiver. The data for transmission may be generated by the communication client 106 running on the OS, or by other applications running under the control of the OS. That data can be passed to the network interface, under the control of the OS, for transmission over the wireless network. Likewise, data received at the network interface 208 over the wireless communication network, such as from users B or C, can be passed to the communication client or to another application under the control of the OS.

The communication client 106 allows a user of the user device to communicate with other users via instant messaging. Referring to FIG. 1, users A, B and C have mutually compatible communication clients 106 installed on their respective devices. The users can run the clients on their devices in order to transmit messages to each other via IM. A user can have a user account for the client that is instantiated on one or more user devices. That user can then access their account from any of those devices. Thus, in a preferred arrangement, messages are directed to particular client instances in dependence on the user account that is authenticated to a client instance rather than being directed in dependence on any identity inherently associated with the hardware or firmware of a particular device. A message directed to a particular user account can be viewable on each device to which that user account has been authenticated.

Each communication client stores in the memory of the device on which it is running a database of messages it has received or transmitted. Each message has a series of attributes. Conveniently each attribute can be held in a respective field of the message. The attributes of each message include:
(i) the identity of one or more user identities with whom the message has been exchanged, i.e. the sender of a message that has been received by the client in question and the recipient of a message that has been transmitted by the client in question;
(ii) message content, for example in the form of any one or more of text, image, hyperlink, audio stream and video stream; and
(iii) a subject field, which can be used to indicate the subject of a message exchange of which the message forms part.

Additional fields may be included, for example a unique identifier for the message and a transmission time for the message.

Examples of the operation of the communication client 106 according to the present invention will now be described with reference to FIGS. 1 to 4.

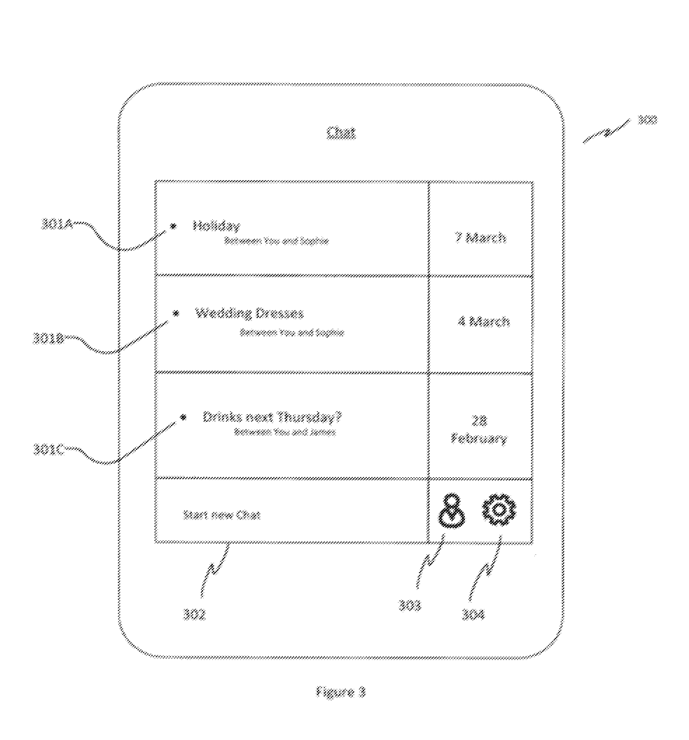

FIG. 3 shows, by way of example, a display forming part of a graphical user interface (GUI) presented to a user of the device 102 when the IM client is active.

Shown in FIG. 3 is a display 300 which lists the most recent conversations had between the user of the device and the user's contacts. The word ‘conversation’ is being used to mean an exchange of related messages transmitted between the user device and one or more of the user's contacts. The messages may be in the form of e.g. text, images, video, file transfer or hyperlink. In the embodiments described herein, the messages are transmitted as instant messages.

The list is presented under the headline of “Chat” to indicate to the user that they are viewing recent conversations, or chats, with their contacts. The headline of “Chat” is merely exemplary and any suitable headline may be used.

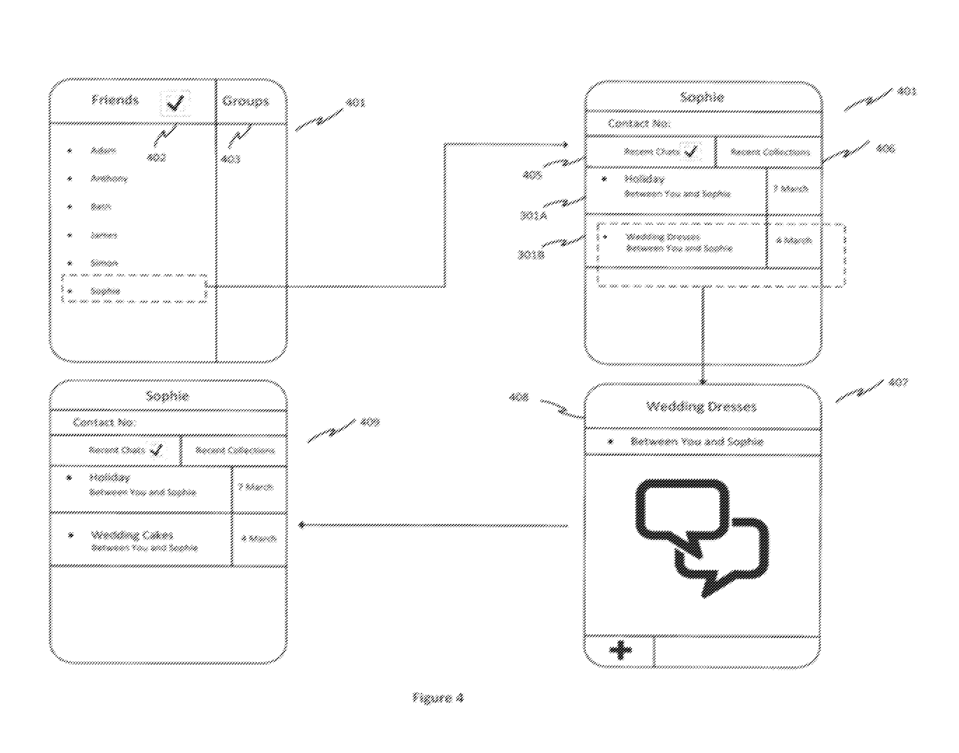

The conversations are presented as a plurality of message threads 301A, 301B and 301C. Each message thread is listed according to a title, or thread descriptor, and lists the participants of the conversation. The title is editable by the participants and characterises the stream of messages contained in that thread (e.g. “Holiday”, “Wedding Dress” and “Drinks next Thursday?”). By selecting a particular message thread, the user can view the messages exchanged as part of that thread and can further transmit and receive messages to add to the conversation. Thus the user can select, or designate a series of existing messages having a common thread identifier and can send a message as part of that series of messages. The client will attribute to the composed message the same thread identifier as is attributed to the existing messages. This will be explained in more detail in FIG. 4.

Each message thread may also state the date at which the last message of the thread was sent. In the example shown in FIG. 3, the message threads are presented in chronological order, with the most recent conversation or thread presented at the top of the list. In other embodiments, the message threads can be presented according to some other order, such as for example in alphabetical order according to the thread title, or according to the participants. The order in which the threads are presented may be chosen by the user.

The title of each message thread may originally be chosen by the participant who starts the conversation. By listing the message threads according to a title, a communication client can allow multiple distinct conversations to be had with the same participants, where each conversation is distinguished by the title of that conversation. In other words, the user can have multiple conversations with the same contact(s), where each conversation can be presented under a separate message thread according to the topic of that conversation.

The instant messages are transmitted to and received from a plurality of remote user accounts. Each instant message has attributed to it a a message thread identifier. Instant messages can be grouped together for presentation to the user according to the thread identifier, i.e. instant messages with a common thread identifier are grouped together as a stream of messages to form a conversation, which may be between two or more user accounts. The thread identifier can also be associated with a title or thread descriptor which can characterise the stream of messages with the same thread identifier.

The title, or thread identifier, is attributed to each instant message independently of the remote user account. That is, messages can be grouped together for presentation to a user according to a thread identifier that is completely independent of user accounts, i.e. independent of the participants of the conversation. This means that the client allows multiple thread identifiers to be used for messages transmitted to and received from a single user account so that multiple message threads can created and be displayed for a single contact.

For example, as shown in FIG. 3, the user of the device has had two previous conversations with the contact Sophie—one of those conversations has the title ‘Holiday’ and is presented as message thread 301A and the other has the title ‘Wedding Dresses’ and is presented as the message thread 301B. This allows users to better categorise their conversations and makes it easier for a user to resume a conversation about a particular topic at a later date, or to refer back to that conversation.

In contrast, for communication clients known in the prior art, conversations or chats are only presented as a single thread for each contact or group of contacts. That is, every conversation had with a particular contact is presented under a single thread for that contact. Typically, this means that in order for a user to revisit a particular topic of conversation had with a contact, it is necessary for the user to scroll through the conversation, reading the messages until they find the ones directed to the topic of interest, which is both time consuming and frustrating for the user. Such clients are “two dimensional” in the sense that any conversation or chat is characterised only by the timeline of the conversation and the participants of the conversation; it is not possible to characterise the conversation by subject matter. The communication client of the present invention can additionally characterise chat by subject matter by attributing to each IM a thread identifier independently of the user account, thereby introducing a third dimension to chat. This additional characterisation improves user experience by allowing users to better segregate their conversations, which is particularly useful should a user wish to re-visit a particular conversation at a later date.

Referring back to FIG. 3, the display also comprises a tab 302 which enables the user to start a new conversation, or chat. Upon selecting this tab, the user will be presented with a list of their contacts who also have the client installed on their user devices. The user can then select the contact with whom they wish to start a new conversation.

The display 300 may further comprise graphical symbols 303 and 304. Symbol 303 is a contact symbol. By pressing this symbol, a page displaying the user's contacts will be displayed on the screen of the user device. The user can then select one of the contacts and a page displaying the plurality of message threads for conversations with that contact will then be displayed. This is explained in more detail with respect to FIG. 4.

Symbol 304 is a settings or menu symbol. By pressing this symbol, a menu of options can be presented to the user. For example, the user can be presented with the option of editing his/her client profile such as by adding a profile picture or updating his/her ‘status’, which may be viewable by the user's contacts. The menu may also provide the user with the option of inviting more of his/her contacts to acquire the client on their devices. By selecting this option, a message such as an SMS message or email can be sent to a chosen contact inviting them to acquire the client, for example by inviting them to download the app.

FIG. 4 shows, according to one embodiment, a series of display screens 400 presented to the user as they navigate through the GUI of the client.

Display 401 is a contact list which lists the user's contacts who also have the same client, or a compatible client installed on their device. Two tabs 402 and 403 (labelled in this example as ‘Friends’ and ‘Groups’ respectively) are displayed which allows the user to select whether to display contacts individually (as shown) or in groups, where the groups can be chosen by the user. In the illustrated embodiment, contacts are displayed either individually or in groups depending on whether tab 402 or 403 is selected, but in an alternative embodiment both lists may be displayed together in parallel.

Display 401 may be displayed when the user presses the contact symbol 303 of display 300. Alternatively or in addition display 401 may be the default page displayed when the client is selected to run.

When the user selects a contact or group of contacts, a page displaying a list of conversations previously undertaken with that contact or group is displayed. For example, selection of the contact ‘Sophie’ causes display 404 to be presented to the user. The display page may display suitable additional information such as the contact's name and contact details, e.g. phone number, email address. It will be appreciated that the selection and arrangement of information shown in display 404 is merely an example and that the person skilled in the art could readily envisage alternative arrangements.

Conversations previously undertaken with the selected contact Sophie are displayed as a plurality of message threads 301A and 301B, similarly to the plurality of message threads illustrated in FIG. 3, with the exception that now only message threads for conversations with the selected contact are displayed. Again, the message threads are displayed and are identifiable by a thread descriptor that characterises the messages forming the conversation contained in that thread (i.e. messages with the same thread identifier). Optionally, the date of the last entry of the conversation may be displayed for additional information.

Selection of one of the message threads causes the stream of messages transmitted between the user device and the user account of the selected contact to be displayed. For example, the selection of thread 301B can cause screen 407 to be displayed. Screen 407 displays the stream of messages transmitted between the user's device and Sophie's account as part of the conversation titled ‘Wedding Dresses’. The stream of messages may be presented in chronological order down the page such that older messages are at the top of the stream with each new message being added to the bottom of the stream. Any messages that are transmitted by Sophie will appear in substantially real-time at the end of the message stream. If the user wants to transmit a message as part of the conversation, they can begin typing a message in window 410. Thus, the user can select a group of messages having a common thread identifier and compose a message as part of the selected group. This composed message will therefore have the same thread identifier attributed to it that is attributed to the existing messages in that group. The client will attribute the correct thread identifier to the composed message in response to the user selecting the group of messages (in this example the messages in thread 301B). Once the user has sent the message, it will be displayed as part of the message stream in substantially real-time. An indication may also be used to indicate to the user whether the message was transmitted successfully or not, for example the message may be displayed in a certain colour once successfully transmitted, or a notice may be displayed in the message stream if the message fails to be transmitted correctly, for example due to poor network conditions.

The thread descriptor characterising the conversation can be displayed, such as in tab 408. The thread descriptor may be editable by either participant of the conversation. In one example, this is done by selecting the tab 408. Upon selection of this tab, the thread descriptor will be presented in editable form which the user can then edit, either by means of a keypad on the device or by means of a displayed graphical keypad in the event the device has a touchscreen. The thread descriptor may originally be chosen by the user who instigates the conversation. If no thread descriptor is chosen when the conversation is started, a default title may be displayed, such as “New Chat”, for example. Alternatively, a default title may be formed from the first set of characters forming the conversation.

Referring back to the example, the user may have originally created the conversation to discuss wedding dresses with Sophie. At some later point in time, the conversation may have drifted towards a different topic, for example wedding cakes. The user can then edit the title of the stream of messages for this message thread to “Wedding Cakes” to better track the current topic of conversation. Upon changing the title for the conversation, a notice may be published in the stream of messages stating that the title has been changed, in order to alert the participants of the conversation.

In some embodiments, changing the title of the stream of messages forming a conversation will cause the respective message thread to be displayed according to the new thread identifier. That is, if for example the user were to navigate back to either page 300 or 401, message thread 301B would now be listed under the new descriptor (e.g. “Wedding Cakes”) rather than its previous descriptor (e.g. “Wedding Dresses”). This is illustrated in display page 409, which is a revised version of display page 406 after the title of the conversation for message thread 301B has been changed. Allowing the user to alter the title of a conversation at any point and then updating the associated message thread to be displayed according to the new title allows the user to continue to categorise conversations even in the event that the topic of the conversation changes.

If the user of a device modifies the thread descriptor for a particular conversation, the client can cause the device to transmit a message that contains an indication of the modified thread descriptor (e.g. “Wedding Cakes”) to the user accounts of the users participating in the conversation. The message can be used by those devices to modify the display of the thread descriptor on those devices, e.g. to change the descriptor to “Wedding Cakes” on each device participating in the conversation.

In some circumstances the thread descriptor for a particular conversation may be changed whilst one or more of the participants are not active in the conversation, for example because they are not logged into their user account. The communication client may be configured so that upon a user logging into their account for the first time since a thread descriptor for a message thread has been changed, the message thread will be displayed using both the previous descriptor and the newly modified descriptor. This may reduce confusion for a user by preventing from looking for a message thread for which the title has changed.

The client may also be configured to maintain a list of each of the thread indicators used for a particular message thread. That is, each message thread can have associated with it a log that tracks the changes made to the thread descriptor for that thread over time. The log may be viewable by the user when the user selects a particular message thread. As an example, a tab may be displayed on screen 407 to enable a user to view the thread descriptors used for that thread (which in our previous example would a log containing the thread descriptors: “Wedding Dresses” and “Wedding Cakes”). The client may also be configured to enable a user to select one of the descriptors within the log, and upon selection display the portion of the message stream at which the descriptor was changed. This may allow users to quickly and easily locate the section of the message stream where the topic of the conversation begins to change.

The client could also be configured to provide a search function to enable a user to search for message threads via a search term. The search term could be used by the client to search for and display an appropriate list of message threads. For example, the client may search for message threads by thread descriptor, so that when a user enters a search term, the client searches for message threads with thread descriptors containing or consisting of that search term. The client could be configured to search both current and past thread descriptors so that a user could search for a particular message thread by its old thread descriptor. Continuing our previous example, the user could, for example, enter the search term “dress” and in response the client could cause message thread 301B to be displayed even though the thread descriptor for this message thread has been changed to “Wedding Cakes”. The search function could be configured so that if it determines that there is only one match to the entered search term, the message stream for the identified message thread could be displayed, rather than the message thread. The search function could be configured to identify thread descriptors that match the entered search term to within a tolerance so that if there is a small error in a search term entered by a user, message threads and/or message streams could still be displayed. The use of such a search function could further aid a user in being able to locate a particular topic of interest without the need for the user to scroll through a list of message threads. In the event that the thread descriptor of a message thread has changed at some previous point in time, the search function could enable the user to locate the desired message thread containing that previous topic of conversation without having to search through the contents of each message thread.

The search term could be entered into a search bar. The search bar could be displayed in response to a user selecting an appropriate tab which could be displayed on one or more of the display screens. For example, display 300 could comprise a search tab which, when selected by the user, causes the search bar to be displayed. Alternatively, the search bar itself could be displayed on one or more of the display screens.

In the foregoing the topics of the conversations and the titles for the message threads have been chosen purely for the purpose of illustration, and the client can be used for any topic of conversation or message threads of the user's choice.

As indicated previously, the client according to the present invention may allow picture messages to be transmitted as part of a conversation with a contact or group of contacts. A user may add a picture message by, for example, selecting the ‘+’ symbol on display page 408, or by other means, such as by way of a dedicated picture symbol.

Picture messages may take the form of simple images, such as those obtained from a user's photo library stored in memory, or obtained from the internet. The user may also be presented with the option of taking an image using a camera of the user device, with the taken image then forming the picture message.

Images may also be selected from a database storing information relating to a particular commercial, economic or social activity, which would allow users to share pictures relating to an activity of their interest. For example, the database may represent a kind of virtual shop where users can search for items (e.g. clothing, homeware, electricals) that they may wish to purchase, or share with the other participants of the chat. The database may be stored at a remote server accessed via the communication network. Pictures taken from this database may be embedded into the message stream in the form of a hyperlink. By selecting the hyperlink, the participants could be directed to a website or webpage where they could purchase the item. Embedding picture messages in this way allows users of the client to quickly and efficiently share and discuss items of interest. The database may also contain virtual items such as podcasts, pdfs, mp3 files, online articles, executable software files, software widgets and apps.

Messages may also be in the form of collections which can be created by a user. A collection can be in the form of a collection of images displayed in a tiled arrangement. The user can select the images for a particular collection from a combination of the sources mentioned above. The collection can then be transmitted to a remote user account in a similar manner to the messages described above. That is, each image within a particular collection can be associated with a common thread identifier. Each thread identifier can be associated with a thread descriptor so that in turn each collection can be associated with a descriptor. The collections may be displayed as a plurality of collection threads, similar to the message threads described above. Selection of a particular collection thread would then cause the images forming that collection to be displayed. Collections may also be displayed as part of a conversation so that a collection can form part of the message stream of a message thread.

For example, a user may wish to make a collection on the topic of shirts. The user can then select a number of images of shirts to form a collection displayed as a tiled arrangement. The user may select some of the images from a persona library, search for images on the internet or alternatively choose images of shirts from an online database representative of a virtual shop. In this way a user may create a type of mood board which can easily be shared with the user's contacts. The user could then create a descriptor for the collection, for example ‘Shirts’. The collection could then be transmitted to a remote user account. The collection could be transmitted with a unique thread identifier so that the images forming the exchanged collection are grouped for display as a collection thread with the descriptor ‘Shirts’. Alternatively, the collection could be transmitted with the thread identifier associated with an existing message thread so that the collection is displayed as part of the message stream for that message thread.

Although the above example has been described in terms of users sharing pictures of purchasable items in the context of shopping, it will be understood that the client of the present invention can be equally applied within other economic, commercial or social domains. For example, the database may contain listings of properties for rent or sale with associated pictures and information. Alternatively, the database may contain information relating to the economic activity of a variety of markets. For example, the database may contain information on price history for various commodities, or the share price for various companies. Such a database may be searchable by region, for example emerging markets and developing markets.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A user device comprising a processor configured to execute a client capable of transmitting and receiving instant messages to and from a plurality of remote user accounts instantiated on a plurality of remote devices, wherein the client is configured to:
attribute to each instant message a thread identifier independently of the remote user account and the content of the message;
group the instant messages for presentation to a user according to the thread identifier and independently of the remote user account;
associate at least some of the thread identifiers with respective thread descriptors; and permit a user to modify a thread descriptor at a time when there exist instant messages to which the thread identifier associated with that thread descriptor is attributed.

2. A user device as claimed in claim 1, wherein the client is configured to permit the user to compose and send a reply message responsive to a message received by the client, by a process including allocating to the reply message the same thread identifier as attributed to the received message.

3. A user device as claimed in claim 2, wherein the client is configured to allocate to the reply message the same thread identifier as attributed to the received message in response to a user designating a series of existing messages to which said identifier is attributed.

4. A user device as claimed in claim 1, wherein the client is configured to permit the user to compose and send a non-reply message, by a process including allocating to the non-reply message a new unique thread identifier.

5. A user device as claimed in claim 1, wherein the client is configured to group instant messages for presentation to a user by displaying a single indicia in representation of a plurality of messages having the same thread identifier, and the client is responsive to the user selecting that indicia to display at least some of the said plurality of messages.

6. A user device as claimed in claim 1, wherein each of the thread descriptors is in the form of a text string.

7. A user device as claimed in claim 6, wherein the client is configured to group instant messages for presentation to a user by displaying the text string in representation of a plurality of messages having the same thread identifier, and the client is responsive to the user selecting that text string to display at least some of the said plurality of messages.

8. A user device as claimed in claim 7, wherein the client is configured to permit a user to modify a thread descriptor associated with a thread identifier by changing the text string and to, in response to such a change transmit to a remote server an indication of the changed text string and the thread identifier.

9. A user device as claimed in claim 6, wherein the client is configured to receive from a server an indication of a change to the change text string associated with a thread identifier and to, in response to such an indication, change the text string it associates with the thread identifier.

10. A user device as claimed in claim 7, wherein the client is configured to permit a user to modify a thread descriptor associated with a thread identifier by changing the text string and to, in response to such a change, group the instant messages having that same thread identifier for presentation to a user by displaying the changed text string in representation of said plurality of messages.

11. A user device as claimed in claim 1, wherein the client is configured to, in response to a user modifying a thread descriptor, transmit a message of a type such as to indicate the modified thread descriptor to remote user accounts with which the user device has exchanged instant messages to which the thread identifier associated with the modified thread descriptor is attributed.

12. A user device as claimed in claim 11, wherein the client is configured to modify a thread descriptor in response to receiving a message of the said type indicating the modified thread descriptor.

13. A user device as claimed in claim 12, wherein the client is configured to group instant messages for display to a user by displaying the modified thread descriptor as indicated in the received message in representation of the plurality of messages having the same thread identifier associated with said modified thread descriptor.

14. A user device as claimed in claim 1, wherein the client is configured to maintain, for each thread identifier, a log of each modification made to the associated thread descriptor, and the client is configured to display the log for a thread identifier to a user.

15. A user device as claimed in any claim 1, wherein the client is configured to receive a search term input by a user and, in response thereto, identify a thread identifier whose thread descriptor or any of whose previous thread descriptors match the search term; and display one or more messages and/or thread descriptors corresponding to the identified thread identifier.

16. A user device as claimed in claim 1, wherein the client is configured to communicate via a server entity dedicated to the intercommunication of all clients with which the client can communicate.

17. A user device as claimed in claim 15, wherein the server is configured to store the thread identifiers.

18. A user device as claimed in claim 1, wherein the client is configured to permit a user to select a group of messages having a common thread identifier and compose a message as part of the selected group; the client being configured to attribute to the composed message the same thread identifier that is attributed to the messages of the group in response to the user selecting the group of messages.

19. A user device for communicating with a remote user account via instant messaging, comprising:
a screen;
a graphical user interface for display on the screen;
a processor operable to run a client, the client being configured to:
attribute to each instant message a thread identifier independently of the remote user account and content of the message;
display by means of the graphical user interface a plurality of message threads, each of the message threads comprising a stream of instant messages transmitted between the client and a single remote user account that share a common thread identifier;
receive an input from a user of the user device to select a message thread from the displayed plurality of message threads;
display on the graphical user interface a stream of instant messages characterised by the selected message thread.

20. A user device as claimed in claim 19, wherein the message thread is independent of the entities of user accounts between which communications have been exchanged in the message thread.

21. A user device as claimed in claim 20, wherein the client is configured to permit a user of the device to create a message as a reply to a message in the displayed stream, and the device comprises a network interface for transmitting the created message as an instant message over a network to a user account.

22. A user device as claimed in claim 19, wherein each of the plurality of threads of instant messages is characterised by a respective title.

23. A user device as claimed in claim 19, wherein each of the plurality of message threads is displayed according to a title characterising the respective instant message stream.

24. A user device as claimed in claim 23, wherein the title characterising the displayed stream of instant messages for the selected message thread is changeable by a user of the local device at a time when there exist instant messages as part of the displayed stream.

25. A user device as claimed in claim 19, wherein to the processor is configured to, once the title characterising the displayed stream has been changed by the user, display the selected message thread according to the changed title.

26. A user device as claimed in claim 19, wherein the client is constituted by executable program code stored in non-volatile memory of the user device.

27. A user device for communicating with a plurality of remote user accounts via instant messaging, comprising:
a screen; and
a processor operable to run a client, the client being configured to:
attribute to each instant message a thread identifier independently of the remote user account and content of the message;
display a graphical user interface on the screen, the graphical user interface comprising a plurality of message threads wherein each of the plurality of message threads comprises a respective stream of instant messages transmitted between the user device and a remote user account that share a common thread identifier and is displayed according to a title characterising the respective stream, wherein message threads are displayed for a plurality of remote user accounts and a plurality of message threads are displayed for at least one remote user account.

28. A user device as claimed in claim 27, wherein the device is one of: a smart phone, tablet, laptop, computer, augmented reality device or console.
